(19) United States
(12) Patent Application Publication
(10) Pub. No.: US 2026/0079900 A1
(43) Pub. Date: Mar. 19, 2026

(54) Parallel Prompting-Based System and Method for Generating AI Outputs

(71) Applicant: Chris Chenault, Mairipora (BR)

(72) Inventor: Chris Chenault, Mairipora (BR)

(21) Appl. No.: 19/289,014

(22) Filed: Aug. 2, 2025

Related U.S. Application Data
(60) Provisional application No. 63/696,487, filed on Sep. 19, 2024.

(51) Int. Cl. G06F 16/215

(52) U.S. Cl. CPC G06F 16/215

(57) ABSTRACT

Artificial intelligence (AI)-driven system and method for generating outputs is disclosed. Multiple AI threads are executed in parallel to generate independent fact groups in response to a user prompt. Facts that are repeated within a single thread are limited to a single copy. The individual thread fact groups are aggregated into a combined dataset, where redundant or erroneous data is filtered out, and consensus is built on the most reliable facts. By counting the frequency of repeated facts across different threads, the system effectively emulates the performance of a high-accuracy AI using lower-accuracy AI models. The facts generated are used to create an output to the original user input. Verification of the output by deconstructing it into facts and comparing it to the reliable facts guarantees the factual quality of the output. The system reduces errors, systematic hallucinations, and random hallucinations, making the AI output suitable for various applications.

### CROSS-REFERENCE TO RELATED APPLICATION

This application claims benefit of U.S. Provisional Patent Application No. 63/696,487 filed on Sep. 19, 2024.

### TECHNICAL FIELD

The present invention relates generally to artificial intelligence (AI), and more particularly, to computer-implemented systems and methods for improving the accuracy of generative AI models to generate outputs for a prompt, using parallel prompting and systematic fact verification, enabling the emulation of high-accuracy AI outputs from lower accuracy AI models.

### Background Art

Generative Artificial Intelligence (AI), for example, large language models (LLMs), has become an increasingly powerful tool in various domains, including content creation, mathematical analysis, model creation, audio generation, programing, image generation, decision support, and information retrieval. LLMs are capable of generating human-like text responses to a wide range of prompts, making them valuable assets in industries such as, but not limited to, healthcare, law, finance, and education. However, despite the capabilities of the existing models, generative AI systems are not without significant limitations, primarily related to the accuracy of the information produced. Errors in generated content, including factual inaccuracies and hallucinations, can undermine the reliability of the existing systems, rendering the existing systems unsuitable for applications where high accuracy is essential.

The inaccuracies generated by existing AI systems may be categorized into three main types: training errors, systematic hallucinations, and actual hallucinations. Training errors arise from inaccuracies present in the data used to train the AI model. Systematic hallucinations occur when the model generates erroneous information based on patterns in the training data, information in prompts, or by using information in another portion of the response. Actual hallucinations are random errors that do not follow any discernible pattern and can vary significantly between different instances of model output. These inaccuracy categories are based on empirical data.

Existing methods to mitigate the above-mentioned errors involve refining the training data, adjusting model parameters, or implementing post-processing techniques. While the existing approaches can reduce the occurrence of certain types of errors, these approaches are often insufficient to eliminate inaccuracies, especially in cases where high precision is required. For example, in legal or medical contexts, even minor inaccuracies may lead to significant consequences, highlighting the need for more robust methods to ensure the reliability of AI-generated content. Accordingly, users still approach AI-generated content with caution, often requiring manual review and verification, which diminishes the efficiency gains that AI systems are supposed to provide.

Further, the lack of a robust validation mechanism in existing generative AI systems exacerbates the problems. While some post-processing techniques exist, the techniques are not sufficient to ensure the high level of accuracy required for certain applications. The inability to consistently validate and cross-check AI-generated facts means that errors can easily slip through, leading to potentially harmful consequences if the information is used without additional verification.

Therefore, there is a well-established need for an improved system and method that can effectively address the various types of errors present in existing generative AI outputs, to enhance the accuracy and reliability of AI-generated content across a wide range of applications.

### SUMMARY OF INVENTION

In an aspect, the present disclosure relates to a computer-implemented method, including receiving, by a system, a user input from a user device associated with a user, modifying, by the system, the user input into a prompt, distributing, by the system, the prompt to a plurality of generative artificial intelligence (AI) threads, each configured to independently generate a set of output data in response to the prompt, aggregating, by the system, the generated set of output data from each of the plurality of generative AI threads into a combined dataset, that dataset is then broken down into atomic facts, (noted simply as facts generally in this document), where atomic facts also are defined as, a discrete, self-contained item obtained from AI-generated output that independently conveys one verifiable proposition, reference or locator, filtering, by the system, the combined dataset of facts based on predefined criteria, determining, by the system, a count of repeated facts from the filtered dataset, verifying facts based on the count of the repeated facts against an empirically derived probability model, or comparison of facts to additional data sources, or additional sets of output data generated by the plurality of generative AI threads, or a combination of these methods, and generating, by the system, a verified final fact table and a final output based on the verified repeated facts in the verified final fact table, to provide a response to the user input.

In an aspect, the method may include dynamically selecting the plurality of generative AI threads based on the content of the prompt and historical accuracy of the plurality of generative AI threads in generating relevant output data. In the embodiment where the LLM is being prompted with no additional information, the repetition of facts within the threads follows a pattern of bias based on the corpora. Since true facts are generally repeated more often in the corpora and specific false facts are not, true facts in many cases are repeated at a higher frequency in the plurality of generated threads.

In an aspect, the predefined criteria for filtering the combined dataset may include a criterion selected from the group consisting of relevance to the prompt, exclusion of data matching known or discovered hallucination patterns, repetition count of facts, factual accuracy, alignment with known data sources, and compliance with domain-specific guidelines.

In an aspect, the method may include generating, by the system, consensus data within the combined dataset by identifying and merging equivalent facts that are expressed in different ways or the same way across the plurality of generative AI threads. A possible exemplar for sentence facts would be to clean them and create embeddings for each sentence, determine cosine similarity, if the similarity was above 0.85, the sentences would then be sent to check for entailment in both directions using RoBerta or a similarly trained NLI model.

In an aspect, the plurality of generative AI threads may be deployed in a distributed computing environment, and the system may be configured to optimize resource allocation for processing the prompt across multiple threads.

In another aspect, the present disclosure relates to a system associated with a digital platform, where the system may include a memory to store instructions, and a processor in communication with the memory. The processor may be configured to execute the instructions to receive a user input from a user device associated with a user, modify the user input into a prompt, or prompts, distribute the prompt or prompts to a plurality of generative artificial intelligence (AI) threads, each configured to independently generate a set of output data in response to the prompt or prompts, aggregate the generated set of output data from each of the plurality of generative AI threads into a combined dataset for each prompt, filter the combined dataset based on predefined criteria, determine a count of repeated facts from the filtered dataset, and in some embodiments additional verification is done of the factuality of the repeated facts against known data sources or additional set of output data generated by the plurality of generative AI threads, and in all cases generate a final fact table based on the verified repeated facts is generated, to be used to provide a response to the user input.

In another aspect, the present disclosure relates to a non-transitory computer-readable storage medium comprising instructions executable by a processor, the instructions to cause the processor to carry out any of the methods disclosed herein.

These and other objects, features, and advantages of the present disclosure will become more readily apparent from the attached drawings and the detailed description of the preferred embodiments, which follow.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 shows an example networked environment with which or in which embodiments of the present disclosure may be implemented.

FIG. 2 shows a block diagram of an example system, in accordance with some embodiments of the present disclosure.

FIG. 3 shows a flow chart of an example method for creating a fact count table, in accordance with some embodiments of the present disclosure.

FIG. 4A and FIG. 4B show example representations of a combined fact data table and a fact count table, respectively, in accordance with some embodiments of the disclosure.

FIG. 5 shows a flow chart of an example method implemented by the proposed system of FIG. 2, in accordance with embodiments of the present disclosure.

FIG. 6 shows an exemplary computer system in which or with which embodiments of the present disclosure may be implemented.

The foregoing shall be more apparent from the following more detailed description of the disclosure.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

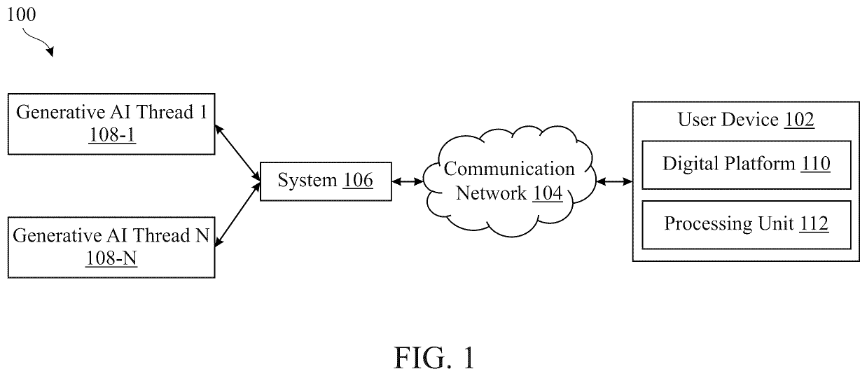

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed implementations. However, one skilled in the relevant art will recognize that implementations may be practiced without one or more of these specific details, or with other methods, components, materials, and the like.

Unless the context requires otherwise, throughout the specification and claims which follow, the word “comprise” and variations thereof, such as, “comprises” and “comprising” are to be construed in an open, inclusive sense that is as “including, but not limited to.”

As used in this specification and the appended claims, the singular forms “a,” “an,” and “the” include plural referents unless the content clearly dictates otherwise. It should also be noted that the term “or” is generally employed in its broadest sense that is as meaning “and/or” unless the content clearly dictates otherwise.

The headings and Abstract of the Disclosure provided herein are for convenience only and do not interpret the scope or meaning of the implementations.

Shown throughout the figures, the present disclosure is directed to computer-implemented systems and methods, with a focus on enhancing the accuracy of generative artificial intelligence (AI) outputs.

The various embodiments throughout the disclosure will be explained in more detail with reference to FIGS. 1-6.

FIG. 1 shows an exemplary networked environment 100, in accordance with some embodiments of the present disclosure.

With reference to FIG. 1, the networked environment 100 may include a system 106 designed to enhance the accuracy of generative artificial intelligence (AI) outputs. The system (106), as shown, interacts with various modules and components that collectively ensure the reliability and precision of AI-generated content. The networked environment 100 is structured to process user inputs or user associated inputs, manage multiple AI threads, filter and verify generated data, and ultimately produce a highly accurate final output. As shown, the networked environment 100 includes a user device 102 associated with a user (not shown) and a plurality of generative AI threads (108-1 . . . 108-N). It may be appreciated that the plurality of generative AI threads (108-1 . . . 108-N) may be individually referred as the generative AI thread 108 and collectively referred as the generative AI threads 108. A person of ordinary skill in the art will understand that there may be any number of user devices 102 and/or generative AI threads 108 within the scope of the present disclosure.

In some embodiments, each user device 102 comprises a digital platform 110 communicatively coupled with the system 106. In some embodiments, the digital platform 110 may be a mobile application (“app”). The mobile application may be installed on the user device 102. In some embodiments, the digital platform 110 may be a web application (e.g., a website or a webpage). In some embodiments, the digital platform 110 may be a desktop application. The digital platform 110 in conjunction with a processing unit 112 may render a graphical user interface on the user device 102 such that a user of the user device 102 may communicate with the system 106 via the graphical user interface rendered on the user device 102. The graphical user interface may be rendered on the user device 102 under control of the system 106. In some embodiments, the digital platform 110 may be hosted on the system 106. In some embodiments, the digital platform 110 may be an AI assistant. The AI assistant may utilize Natural Language Processing (NLP) to understand and process user inputs in natural language, a spoken language interpreter that translates speech into a user input, motion detection inputs from a user or device that has been configured to output them as generative AI input, optical inputs that have been configured as generative AI input, other sensors inputs passing through a device that have been configured to output them as generative AI input, a brain wave interpreter that translates such signals into a user input, or programs that have been configured to interpret stored data for generative AI inputs. In some embodiments, users may communicate with the AI assistant via voice commands, text, brain waves, gestures, video, images, or other means of communication.

Referring to FIG. 1, the system 106 may be communicatively coupled to the user device 102 via a communication network 104. In some embodiments, the system 106 may include suitable logic, circuitry, interfaces, and/or code that may be configured to receive a user input or user associated input or request from the user device 102 associated with the user. In an example embodiment, the user input may include a medical query, a legal document summary, technical information retrieval, educational content generation, business intelligence request, historical information query, product information request, scientific research assistance, and the like. For example, the user may provide the input “Generate a report on the impact of climate change on polar bear population” to the system 106 via the digital platform 110. It may be appreciated that user input may include a wide range of queries across different domains within the scope of the present disclosure. In some embodiments the system 106 may request additional information from the user device 102 for clarity regarding the prompt. For example, “Will the audience for the impact of climate change on polar bear population be children (ages 6-13), high school students, college students, or academics?” Since the final form of the prompt for the system 106 to query for facts about climate change would be better able to match the context. In an exemplary test, implementing the parallel prompting approach on a 599 URL fact dataset, (facts in this case being URLs), generated with 20 individual AI threads on GPT 3.5, the factual accuracy went from an average of 39% in the initial URL set to 100% in the final fact table using a novel filters, where accuracy for this particular case is defined as, The number of relevant live URLs/All URLs in the URL Set. Specifically, the system used multiple AI threads, with the prompt, “ . . . 1) Please act as an expert teacher in general relativity. I would like you to make a list of the 30 most relevant online sources to teach about general relativity to a general audience. 2) Again Acting as an expert please create a “relevance rating” for each online reference that you included in your list based on how well it matches the requested information. Your rating should be closer to 0 if the information is not relevant and 100 if it is perfectly relevant Please respond with your reference list . . . ” After collating equivalent URLs into a consensus URL, (e.g. http://www.yahoo.com/->https://yahoo.com), analysis showed that after filtering all URLs that were repeated in the same thread to leave only one instance and removing all URLs that ended in a folder containing the words “general” or “relativity” the remaining URLs that were repeated at least 3 times in different threads were 100% accurate in this particular case. The fact that almost all systematic hallucination errors in URL generation include the subject or parts of the subject of the prompt in the final folder makes this possible and can be easily proven with a p-test. The number of repeats needed to significantly improve accuracy being 3 was found empirically over several different URL data sets this same size +/−1 with and initial accuracy range of 39% to 87%. In all experiments done there was a quantitative improvement in accuracy compared to the initial accuracy to 98% or greater. Further the relevance score GPT 3.5 created was statistically meaningless, GPT 3.5 in this case was not able to judge the most relevant URLs This leaves the repeated fact count in the final fact table as a better representation of relative importance because the number of times a URL appears in the training corpus is known to affect the number of times it appears in results, in practice the number of repeats of accurate URLs in our data fits a decaying exponential curve. This is similar to the method Google initially used in its PageRank algorithm to determine the importance of a website using incoming links and suggests that the parallel prompting method will have similar strengths and weaknesses in finding accurate facts including: bias to the most commonly repeated and potentially most important facts in the training corpus and exclusion of important new facts rarely repeated in the training corpus. The inclusion of domain trained AI models will shift the most repeated facts within a particular domain, use of a fine tuned model or additional content added to a prompt can significantly alter the frequency of fact output and content, and most importantly the use of a Retrieval Augmented Generation (RAG) method with curated data can significantly limit and alter possible fact repetitions in LLM output. Internal adjustments of the LLM such as temperature can also significantly alter the variation of generated facts. The parallel prompting method relies on novel parallel AI threads, collating equivalent facts, novel filters, iterative fact checking, and partial regeneration of outputs in some embodiments based on recognized triggers, which allows accuracy verification at scale.

Referring to FIG. 1, examples of the system 106 may include, but are not limited to, a computer workstation, a mainframe computer, a handheld computer, a cellular/mobile phone, and other computing devices. In some embodiments, the system 106 may be implemented as a cloud server which may execute operations through web applications, APIs, cloud applications, Hypertext Transfer Protocol (HTTP) requests, repository operations, file transfer, and the like. Other examples of the system 106 may include, but are not limited to, a database server, a file server, a web server, a media server, an application server, a mainframe server, a cloud server, or other types of servers. In some embodiments, the system 106 may be implemented as a plurality of distributed cloud-based resources by use of several technologies that are well known to those skilled in the art.

In some embodiments, the user device 102 may include suitable logic, circuitry, interfaces, and/or code that may be configured to receive the user input from the corresponding user. Specifically, the user device 102 may be configured to receive the user input from the corresponding user and transmit the received user input to the system 106, or transmit a preprogrammed optimized instructions in response to either the user associated input or analysis of such input, or both.

Examples of the user device 102 may include, but are not limited to, a robot, a car, a telephone, a smartphone, a cellular phone, a mobile phone, a personal digital assistant (PDA) device, a tablet, a gaming device, a computing device, an imaging device, a mainframe machine, a server, a computer work-station, and the like. In some embodiments, the user device 102 may include, but is not limited to, any electrical, electronic, electro-mechanical, or an equipment, or a combination of one or more of the above devices such as virtual reality (VR) devices, augmented reality (AR) devices, a general-purpose computer, desktop, personal digital assistant, mainframe computer, or any other computing device, wherein the user device 102 may include one or more in-built or externally coupled accessories including, but not limited to, a visual aid device such as camera, audio aid, a microphone, a keyboard, and input devices for receiving input from the corresponding user such as touch pad, touch enabled screen, electronic pen, and the like.

A person of ordinary skill in the art will appreciate that the user device 102 may not be restricted to the mentioned devices and various other devices may be used.

In some embodiments, the user device 102 may include a display device. The display device may include suitable logic, circuitry, and interfaces that may be configured to display the user input(s), confirmation message, user information, or the like. The display device may be further configured to display a set of user interface (UI) elements to receive the user input and/or request. The display device may be a touch screen which may enable the corresponding user to provide the user input via the display device. The touch screen may include, but not be limited to, a resistive touch screen, a capacitive touch screen, or a thermal touch screen. The display device may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with some embodiments, the display device may refer to a display screen of a head mounted device (HMD), a smart-glass device, a see-through display, a projection-based display, an electro-chromic display, or a transparent display.

Referring to FIG. 1, the communication network 104 may include a communication medium through which the system 106 and the user device 102 may communicate with each other. The communication network 104 may be a wired or wireless communication network. Examples of the communication network 104 may include, but are not limited to, the Internet, a cloud network, a Wireless Fidelity (Wi-Fi) network, a Personal Area Network (PAN), a Local Area Network (LAN), a fiber optic network, a Metropolitan Area Network (MAN) or other similar types of networks. Various devices in the networked environment 100 may be configured to connect to the communication network 104, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), HTTP, File Transfer Protocol (FTP), API protocol, wireless access point (AP), device to device communication, cellular communication protocols, and Bluetooth (BT) communication protocols, or the like.

The networked environment 100 may also include a plurality of generative AI threads 108 that may provide data to the system 106. Generative AI threads 108 refer to multiple independent instances of a generative AI model, each working on the same input prompt but functioning as separate, isolated processes. The purpose of using multiple threads 108 is to mitigate the risk of errors or biases that may arise if only a single AI instance were used. By generating output through several independent threads, the system 106 increases the likelihood of identifying accurate information and filtering out anomalies or hallucinations.

When a user input or user associated input is received from the user device 102, the system 106 modifies the user input into a fact gathering AI input, which may be in the form of an optical information, jpgs, etc or a prompt (or prompts), suitable for further processing by the system 106 and/or the plurality of generative AI threads 108. For example, the user's original query is transformed into a more refined, targeted prompt by the system 106, to ensure that the query is clear and unambiguous, reducing the chances of misinterpretation by the AI threads 108. In some embodiments, this may require a request for clarification from the system 106 to the user device 102. The system 106 structures the input in a way that aligns with the strengths of the generative AI models, making it easier for the AI threads 108 to generate accurate and comprehensive responses. In some embodiments, the system 106 first analyzes the user's original query to understand its intent, context, and the type of information being requested. If the user has provided additional context or background information, such as documents or reference materials, the system 106 incorporates the additional information into its analysis to fully understand the scope of the query. In some embodiments, the system 106 may prompt the user to provide additional contextual information to clarify the prompt.

If the user input or user associated input is complex or multifaceted, the system 106 may decompose the query into simpler, more manageable sub-queries. The decomposition allows each AI thread 108 to focus on a specific aspect of the query, which can then be aggregated to form a comprehensive response. For example, for a query like “What are the economic, environmental, and social impacts of climate change?” the system 106 may break the query down into three sub-queries or prompts: “What are 30 important facts about the economic impacts of climate change?” “What are 30 important environmental impacts of climate change?” and “What are 30 important social impacts of climate change?” In some embodiments, the system 106 may use an iterative parallel prompt process to break a prompt into sub-prompts. The iterative parallel prompt process may refer to a mechanism where the output of one parallel prompt process is fed as input of the next parallel prompt process. An example prompt for the same may be “Please take the prompt that I am sending you and break it into 2 prompts that are simpler to answer but still include all of the queries of the original prompt. Restate the prompts as requests for 30 facts concerning the subject of the prompt. If you are not able to break the prompt down further respond, ‘Not able to break this prompt down more.’ Prompt: Why is the sky blue but sunsets are red?” Prompts containing multiple sub prompts may be processed using parallel prompting iteratively including cross-checks to verify that all sub prompts are correct and included.

In some embodiments, the system 106 may enhance the prompt, or the AI input, by incorporating additional context or background information that was either provided by the user, requested for clarification, or retrieved from relevant databases. For example, if a user asks about the latest research on a specific medical treatment, the system 106 may add references to the most recent clinical trials, related research papers, or other curated information to guide the AI threads 108.

In some embodiments, the system 106 may identify and emphasize key terms or phrases that are crucial to the query. For example, for a query about cloud security, the system 106 may emphasize terms like “data encryption,” “access control,” and “multi-factor authentication.” Based on the refined query, the system 106 may generate a structured prompt that is optimized for AI processing. This prompt might include specific instructions or formatting that align with the capabilities of the generative AI threads.

Therefore, by clarifying and refining the query, the system 106 reduces the risk of generating irrelevant or inaccurate information. The structured prompt ensures that the AI threads 108 focus on the most relevant data, leading to a more targeted and useful response. By optimizing the input for AI processing, the system 106 can generate accurate outputs more efficiently, reducing the time and computational resources required.

In some embodiments, the system 106 may parse video, image, or audio data into smaller pieces to be analysed in parallel. For example, along with the prompt, “Please correct any AI aberrations in this AI generated image,” an image may be sent to the AI threads 108, along with the original image generating prompt, for example. The system 106 breaks the image using an overlapping grid and uses parallel prompt threads to determine if the current portion of the grid contains AI aberrations. The parallel prompt facts generated in this case are “Yes” or “No” votes about the presence of an AI aberration. An example of an AI image aberration may be an image of a dog with two tails. That portion of the image and the surrounding grid locations may be regenerated to try to correct the aberration based on the content of the grids images and the original image generating prompt if available. An iterative process may then occur where the image may be reanalysed until it no longer contains any aberrations or a set number of iterations had been processed.

In some embodiments, the original prompt may need to be clarified and broken down by the system 106 into smaller steps that will need to be processed sequentially. For example, for the prompt, “Please write a program that pulls the current value of ABC's stock options every 10 minutes while the exchange is open and stores them together in a spreadsheet,” the system 106 may first request for clarification, for example, “Does ABC's website include all the information that you need?”, “I will write the program in a language (Python) assuming you have the plugin is that acceptable?”, “I will have the program write the output spreadsheet in a CSV format usable in spreadsheets, is that acceptable?”, etc. Following that, the original query may be broken down into steps using the additional clarifying information and the original prompt, “Please take the programming prompt that I am sending you and break it into 2 prompts that together contain all of the programming steps of the original prompt. If you are not able to break out additional steps from the programming prompt reply, ‘Not able to break this prompt down more.’” If used iteratively, the system 106 may create a set of prompts that can be executed sequentially with parallel prompting using the information from the previous prompt output to create the program with consistent variables, subroutine calls, etc. The “parallel prompting facts” being compared in the case with parallel prompting will be small amounts of programming code (snippets) with a particular purpose, variables, etc. A voting parallel prompt may be used to determine if the code snippets are equivalent and will function for the particular purpose.

In some embodiments, the system 106 may use an optimized prompt to be sent to the AI threads 108. The optimized prompt may have been proven to provide accurate and complete responses. For example, an optimized prompt generated by the system 106 when analyzing an X-ray may be “In the X-ray data provided, please identify any abnormalities including fractures, osteopenia, infections, an enlarged heart, etc.” In some embodiments, the optimized prompt may include blanks for the user to fill in.

Referring to FIG. 1, the system 106 distributes the prompt to the plurality of generative AI threads 108. The system 106 dynamically allocates computational resources to instantiate multiple AI threads 108. Each thread 108 is configured with its own environment, ensuring that there is no crosstalk or data leakage between threads 108. Each thread 108 operates independently, meaning that the output of one thread does not influence the others. This independence is crucial for maintaining the diversity of responses, which is later leveraged for cross-verification. In some embodiments, the number of threads 108 is determined based on the complexity of the query, the need for accuracy, and the availability of computational resources. As an example, the system 106 may use 20 or more threads 108 to ensure a broad and reliable dataset.

Once initialized, the generative AI threads 108 begins processing the prompt independently. Each thread 108 retrieves relevant information from a source or various sources, such as databases, documents, research papers, or pre-trained knowledge bases. The retrieval strategy may differ between threads 108 to ensure that the system 106 explores a wide range of possible answers. After gathering the necessary data, each thread 108 generates content or responses based on the prompt. This content generation is governed by the underlying generative AI model, which may be a Large Language Model (LLM) like GPTTM, or a domain-specific model trained on specialized data. In some embodiments, within each thread 108, there may be an initial filtering process where obvious errors or irrelevant data are discarded. However, this filtering is limited to avoid removing potentially useful information that could be cross verified later.

The generated output from each thread 108 is sent back to the system 106 for further processing. Each thread 108 may produce different outputs, or in some cases, similar outputs, depending on the prompt and data retrieval results. The diversity of responses generated by the multiple AI threads 108 is critical for the system's accuracy. Different threads 108 may access slightly different data sources, interpret the prompt in slightly different ways, and generate varied responses based on the probabilistic nature of generative models. It is important to note that bias in LLM generation favors facts that have often been repeated in its corpus and are thus generally more reliable. Additional content, fine tuning, domain trained LLMs, or Retrieval Augmented Generation can change this bias for particular facts.

By comparing outputs across threads, the system 106 may identify facts that are consistently reported, which are likely to be accurate. If one thread 108 produces a significantly different result from the others, the output may be flagged for further review or discarded as a potential anomaly or hallucination. If a systemic error exists in the AI model, it may be less likely to affect all threads uniformly, allowing the system 106 to filter out erroneous outputs.

In some embodiments, the system 106 receives the set of output data from each AI thread 108 and compiles into a combined dataset. The system 106 compares outputs from different threads 108 to identify commonalities and discrepancies. Facts or information that are repeated across multiple threads 108 are flagged as more reliable. Predefined criteria may be applied by the system 106 to remove outputs that appear to be hallucinations or systemic errors, ensuring that only reliable data is carried forward. The frequency of specific facts or repeated facts across the threads 108 is counted by the system 106. High-frequency facts are considered reliable and are cross-verified against known data sources. After fact verification a final fact table is constructed.

Accordingly, the system 106 produces a proposed final output based on the final fact table thereby providing a response to the original user input or query. In some embodiments, the system 106 uses the final fact table to generate the proposed final output to the original user input. The proposed final output is created by restricting the system 106 to only use the verified facts gathered in the final fact table. In some embodiments, the proposed final output generated by the system 106 is again sent through another set of threads in 108 to break it down into the facts used to create it by chunking it into labeled portions and using LLM queries, to extracted a set of facts from each labeled portion which are then compared with the verified facts in the final fact table. If facts are present that were not included in the final fact table the labeled portion is regenerated and retested. If the same new fact or facts are found over several regenerations they are tested across the threads 108 in some embodiments using tuned LLMs, domain trained LLMs, or outside sources. If a fact or facts are verified they are added to the final fact table. If regeneration and new fact checking fail after a user determined number of iterations an error is generated. Once all labeled portions have been verified the final output is checked to verify that it is a complete response to the original prompt by using either the original prompt or sub-prompts that it was broken into and querying using the threads 108. By systematically checking and cross-referencing information, the system 106 minimizes the risk of inaccuracies, making it suitable for applications where high precision is critical.

In some embodiments the system may further leverage the verified final fact table to automatically generate synthetic training data for use in adapting or updating generative AI models. For each verified atomic fact in the table, the system may programmatically generate a corresponding synthetic query designed to elicit the fact when answered. Such queries may be constructed using parallel prompting methods, template-based approaches, or language modeling techniques. The resulting query fact pairs are stored in a reinforcement dataset. This dataset may then be used to train, fine-tune, or steer a generative AI model using techniques including reinforcement learning or prompt-weighted adjustment. As a result, the model may progressively learn to integrate newly verified facts, improving the factuality and adaptability of the generative outputs over time without requiring manual labeling.

In an exemplary application a set of 10 chunks were generated in parallel using exactly the same prompt to an LLM that included a set of facts about mitochondria. The 10 chunks were generated using gpt-40-mini with a temperature setting of 0. The chunks were all variations of the introduction section for a chapter about mitochondria for an undergraduate audience. The mitochondria facts in the prompt were generated with a separate prompt using system 108 and included 78 facts in this example that were generated using gpt-40-mini with a temperature setting of 0 using 20 threads requesting in the prompt for relevant facts that could be used to write the introduction of a chapter of a textbook about mitochondria. Facts that were repeated within a single thread after cleaning had their count reduce to one within the thread. Facts that had more than one identical copy after cleaning on different threads were considered to be verified and sent to verified final fact table. The 10 chunks were analyzed with 20 threads per chunk (a total of 200 threads) for facts included in the chunk, Each thread generated roughly 35 individual facts. Rather than using embedding cosine measures to determine fact closeness and a NLI trained Large Language Model like RoBerta to determine entailment of the facts, the facts were cleaned by having all letters set to lower case and all punctuation removed as well as any spaces not a part of the sentence itself. After the cleaning procedure any facts that were an exact match to one another were considered to be equivalent consensus facts. This procedure is simpler and faster than using embedding vectors and a NLI trained LLM although it can miss equivalent consensus facts that are written differently. (This issue can be addressed in the final fact table with a cosine embedding distance analysis combined with a NLI analysis for close facts (cosine similarity of 0.69 or above based on empirical data). This may necessitate some recalculations however.) When the temperature is set to a low value the variation in the generated facts is lower allowing for fewer chunks and threads to be used in generating a passing chunk For the 20 threads analyzing a particular chunk the facts generated were cleaned and any duplicate facts within a particular thread were deleted to avoid systematic hallucinations. Any facts that were included in more than one of the 20 separate chunk analysis threads were consider verified in terms of those facts being present in the chunk being analyzed. The final fact lists for each chunk were then compared against each other and any fact that was replicated in more than one final fact list for different chunks was considered to be a verified fact and added to the verified final fact table along with the original 78 previously verified facts from the chunk generating prompt. In this test a total of 114 facts were found. The facts associated with each chunk's final fact table were compared against the verified final fact table. If all the facts verified to be present in a particular chunk could also be found on the verified final fact table then that chuck passed factual verification. In this particular test with the temperature turned down to 0 a 100% pass rate was observed. In other words any of the 10 chunks generated contained only verified facts and could be used with confidence as a textbook introduction to a mitochondria section.

In some embodiments a document may be updated using a second data source. An example of this would be re-writing a textbook based on newly available scientific evidence. In this case the original text, photos, graphs, video, audio, transcripts, illustrations, data source, or other content generated from them are chunked and analyzed using system 108. The final fact tables for each chunk in this embodiment are combined retaining a label designating what chunk or chunks contained those facts. The textbook final fact table is checked for internal consistency and any contradictions logged, and dealt with programmatically or by user feedback. A second revising document, documents, photos, graphs, illustration, audio transcript, video, or other data source or content generated from them is analyzed in an equivalent manner. This second final fact table is checked for internal consistency and any contradictions logged, and dealt with programmatically or by user feedback. The second final fact table is then compared to the first. Any chunk of the textbook that contains a fact that contradicts the second final fact table is flagged for review either by a user or programmatically for editing. In some cases editing may be done programmatically by regenerating the chunk using the second final fact table and/or other data sources as content in the prompt and then checking the result against the second final fact table, or by verifying new facts using system 108 or, using other data sources. In others cases user input may be required to correct the chunk. Finally in some embodiments all edits are logged with the original data stored, data sources noted, and the final fact tables saved to speed future editing tasks.

In some embodiments, for example a summary of a patient and doctors interaction, a document or documents, photos, graphs, video, audio, transcripts, illustrations, data source, or other content generated from them are chunked and analyzed using system 108. The final fact tables for each chunk in this embodiment are combined retaining a label designating what chunk or chunks contained those facts. The content final fact table is checked for internal consistency and any contradictions logged, and dealt with programmatically or by user feedback. A summary is generated using the final fact table. In some embodiments the summary might consist of filling out a form where specific data is needed and areas for less structured content may be provided. The summary will be chunked and analyzed, missing information in this case will be noted and the user informed, In some cases an completely unstructured summary will be created. In some cases the summary may follow an outline. In some cases facts from the documents may be flagged as vitally important to the summary either programmatically or by the user and if not present may trigger a chunk regeneration and verification or a request for user input with a limited number of iterations. The summary final fact table will also be checked against the content final fact table for additional facts or contradictions. For chunks of the summary that fail the comparison of their final fact table against the original content final fact table will be regenerated and if they continue to fail new facts may be verified using the system 108, programmatically, using an outside source, or by user input depending on the embodiment. Finally the verified summary is sent to the user, saved, and in some embodiments data sources and fact tables logged.

By utilizing multiple independent generative AI threads 108, the system 106 significantly increases the accuracy of its outputs. Each thread 108 processes the same prompt independently, allowing the system 106 to cross-verify and aggregate consistent information across threads 108. This parallel processing approach reduces the likelihood of errors, misinformation, or systemic hallucinations that may occur if only a single AI instance were used, leading to highly accurate and reliable outputs, making the system 106 particularly valuable in applications where precision is critical, such as in legal, medical, or technical domains, but not limited to the like.

The system 106 incorporates a robust fact verification process that cross-references facts generated by the AI threads 108 against known data sources. By systematically filtering and verifying the information, the system 106 ensures that only the most accurate and relevant data is used in the final output, thereby minimizing the risk of false information, enhancing the trustworthiness of the AI-generated content. Further, the system's architecture is designed to be highly scalable, allowing the system 106 to handle multiple queries simultaneously without compromising on processing speed or accuracy. The use of parallel threads and efficient aggregation methods ensures that the system 106 can process large volumes of data quickly.

In some embodiments, the system 106 may be configured to learn from its outputs over time, adapting to new data and refining its processes based on feedback. The adaptive learning capability ensures that the system 106 remains up to date with the latest information and continues to improve its accuracy and relevance. Further, the system 106 can be easily integrated with existing databases, knowledge management systems, and external data sources, allowing for seamless access to up-to-date information. This integration capability ensures that the system 106 can function effectively in a wide range of environments.

Although FIG. 1 shows exemplary components of the networked environment 100, in other embodiments, the networked environment 100 may include fewer components, different components, differently arranged components, or additional functional components than depicted in FIG. 1. Additionally, or alternatively, one or more components of the networked environment 100 may perform functions described as being performed by one or more other components of the networked environment 100.

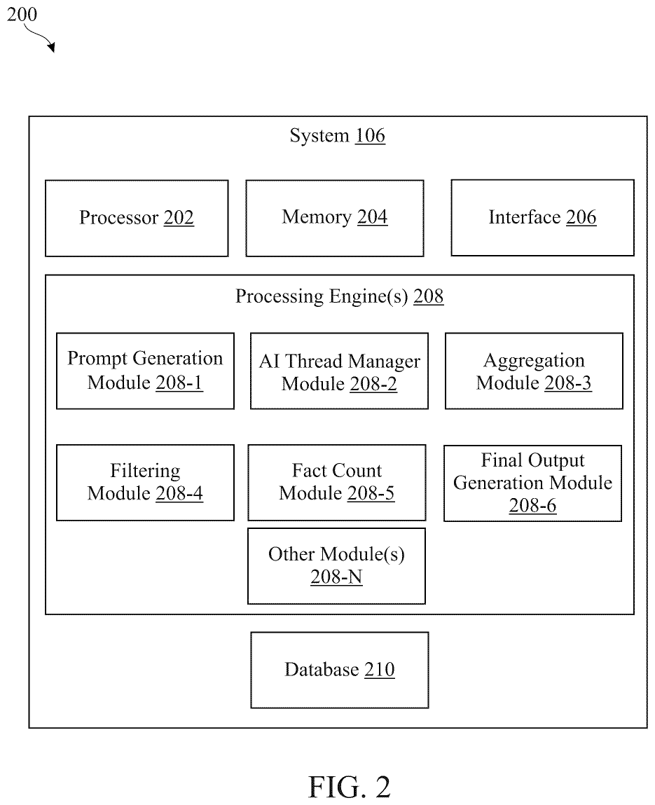

FIG. 2 shows a block diagram representation 200 of an exemplary system 106, in accordance with some embodiments of the present disclosure.

Referring to FIG. 2, the system 106 may include a processor 202, a memory 204, interface(s) 206, processing engine(s) 208, and a database 210. In some embodiments, the processor 202 may include suitable logic, circuitry, and interfaces that may be configured to execute program instructions associated with different operations to be executed by the system 106. For example, some of the operations may include, but are not limited to, receiving user input, modifying user input into a prompt, distributing the prompt to a plurality of AI threads (e.g., 108), receive a set of output data from each AI thread 108, aggregate the set of output data into a combined dataset, filter the combined dataset, determine a count of repeated facts in the combined dataset, and generate a final output. In some embodiments, the processor 202 may execute an application (for example, as a mobile application or website application), an AI assistant, an AI robot, or the like.

In some embodiments, the one or more processor(s) 202 may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) 202 may be configured to fetch and execute computer-readable instructions stored in the memory 204 of the system 106. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as Random-Access Memory (RAM), or non-volatile memory such as Electrically Erasable Programmable Read-only Memory (EPROM), flash memory, and the like.

In some embodiments, the system 106 may include the interface(s) 206. The interface(s) 206 may comprise a variety of interfaces, for example, interfaces for data input and output devices, referred to as input/output (I/O) devices, storage devices, and the like. The interface(s) 206 may facilitate communication for the system 106. The interface(s) 206 may also provide a communication pathway for one or more components of the system 106. Examples of such components include, but are not limited to, the processing engine(s) 208 and the database 210. In some embodiments, the database 210 may comprise data that may be either stored or generated as a result of functionalities implemented by any of the components of the system 106. The database 210 may store the user input. In some embodiments, the database 210 may store the results or output generated by the AI threads 108. In some embodiments, the database 210 may store the final output.

In some embodiments, the interface(s) 206 may include suitable logic, circuitry, and interfaces that may be configured to facilitate a communication between the processor 202 and the user device 102 via the communication network 104. The interface(s) 206 may be implemented by use of various known technologies to support wired or wireless communication of the system 106 with the communication network 104. The interface 206 may include, for example, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

In an embodiment, the processing engine(s) 208 may be implemented as a combination of hardware and programming (for example, programmable instructions) to implement one or more functionalities of the processing engine(s) 208. In examples, described herein, such combinations of hardware and programming may be implemented in several different ways. For example, the programming for the processing engine(s) 208 may be processor-executable instructions stored on a non-transitory machine-readable storage medium and the hardware for the one or more processors 202 may comprise a processing resource (for example, one or more processors), to execute such instructions. In the present examples, the machine-readable storage medium may store instructions that, when executed by the processing resource, implement the processing engine(s) 208. In such examples, the user device 102 may comprise the machine-readable storage medium storing the instructions and the processing resource to execute the instructions, or the machine-readable storage medium may be separate but accessible to the user device 102 and the processing resource. In other examples, the processing engine(s) 208 may be implemented by an electronic circuitry.

In an exemplary embodiment, the processing engine(s) 208 may include a prompt generation module 208-1, an AI threads manager module 208-2, an aggregation module 208-3, a filtering module 208-4, a fact count module 208-5, a final output generation module 208-6, and other module(s) 208-N. The other module(s) 208-N may implement functionalities that supplement applications/functions performed by the processing engine(s) 208.

In some embodiments, the prompt generation module 208-1 may modify the initial user input to generate a more structured and focused prompt suitable for processing by the AI threads 108. The modification may involve decomposing complex queries, clarifying ambiguities, requesting additional contextual information from the user device 102, and enhancing the input with additional contextual information if necessary. In some embodiments, the modification process uses NLP or other algorithms to refine the user input. If the user provides additional context, such as reference documents, links, images, videos, audio, or supplementary data, the prompt generation module 208-1 may integrate the information into its analysis to generate the prompt. In some embodiments, before the prompt is sent to the AI threads manager module 208-2, the prompt may be validated by the prompt generation module 208-1 to ensure that the prompt is compatible with the AI threads'processing capabilities, for example, checking for completeness, coherence, and alignment with the expected output format. If any issues are detected during validation, the prompt generation module 208-1 may automatically adjust the prompt or request additional input from the user to resolve the issue.

The prompt generation module 208-1 may be closely integrated with the underlying AI models to ensure that the prompts generated by the prompt generation module 208-1 are fully compatible with the models'capabilities. It may be noted that prompt generation may occur in real-time, minimizing delays between user input and AI processing.

In some embodiments, the AI threads manager module 208-2 may be responsible for distributing the prompt across multiple independent AI threads 108. Each thread 108 operates independently, processing the same prompt to generate diverse outputs that are later aggregated and compared. The AI threads manager module 208-2 dynamically allocates computational resources to initiate multiple AI threads 108. After each thread completes its execution, the AI threads manager module 208-2 may collect the generated set of output data (interchangeably referred to as “fact groups”). The AI threads manager module 208-2 may perform an initial filtering step to remove obviously flawed or incomplete outputs before passing them to the aggregation module 208-3.

By managing multiple AI threads 108 simultaneously, the AI threads manager module 208-2 significantly reduces the time required to process complex queries while increasing the accuracy of the results through parallel verification. The AI threads manager module 208-2 may handle a large number of threads 108 and complex queries without a degradation in performance, making the system 106 suitable for high-demand environments and large-scale applications.

Referring to FIG. 2, the aggregation module 208-3 collects and consolidates the set of output data from each AI thread 108 into a single, comprehensive combined dataset. The aggregation may include sorting, ranking, or organizing the data based on relevance, consistency, and other like parameters. In some embodiments, the aggregation module 208-3 may assign relevance scores to the different pieces of data based on their alignment with the user's query and the system's predefined criteria. Relevance scoring may involve using algorithms that evaluate the frequency of certain keywords, the contextual alignment with the prompt, or the consistency of data across multiple threads 108. Data that scores higher on these metrics is prioritized for subsequent processing.

The aggregation module 208-3 may handle various types of data, including text, numerical data, and multimedia content. The integration strategies adopted by the aggregation module 208-3 may be adaptable to different data formats and structures.

In some embodiments, the filtering module 208-4 filters the combined dataset provided by the aggregation module 208-3 based on predefined criteria. The filtering module 208-4 applies a series of filters to the aggregated dataset to remove irrelevant, redundant, or erroneous information. The filtering module 208-4 specifically targets systemic hallucinations and other inaccuracies that are common in generative AI outputs. Advanced algorithms may be used to detect patterns that indicate potential errors or hallucinations, relying on predefined criteria. In some embodiments, the predefined criteria may include, but not limited to, statistical analysis, pattern recognition, or other AI techniques. The filtering module 208-4 employs advanced pattern recognition and anomaly detection algorithms to identify outputs that deviate significantly from expected norms. The filtering module 208-4 may compare generated data against known datasets or use statistical outlier detection methods to flag and remove hallucinations. For example, if an AI thread 108 generates a fact that has no basis in the real world or contradicts widely accepted knowledge, this fact would be identified and filtered out by the filtering module 208-4.

In some embodiments, the filtering module 208-4 may identify and remove redundant data that may have been generated by different AI threads 108. Redundancy elimination involves comparing data points for similarities using techniques such as hash functions, cosine similarity using embedding vectors with empirically determined limits, NLI trained LLMs to detect mutual entailment with empirically defined limits, exact matching, or fuzzy matching, but not limited to the like. The filtering module 208-4 identifies duplicates or near-duplicates and retains only the most representative instance of each unique piece of information. In some other embodiments, the system 106 may send a prompt to the AI threads 108 to confirm if one fact is the same as another, for example, if the facts pass a statistical distance test. For example, for the statistical distance test, the prompt may be: “Fact 1: The sky is a beautiful blue color. Fact 2: The sky is blue. Please respond with ‘Yes’ and only ‘Yes’ if fact 1 is factually equivalent to fact 2 and ‘No’ and only ‘No’ if they are not equivalent.”

In some embodiments, the filtering module 208-4 may apply domain-specific filters based on the type of query or the context of the data, allowing for more targeted filtering tailored to the needs of specific fields, such as legal analysis, medical research, or technical documentation. For example, in a legal context, the filtering module 208-4 may filter out data that lacks legal precedence or is not relevant to the jurisdiction in question.

Referring to FIG. 2, the fact count module 208-5 may analyze the filtered dataset to identify and count facts that are repeated across multiple AI threads 108. Repetition of facts across threads may be used as an indicator of reliability. The fact count module 208-5 may identify individual facts or data points within the aggregated dataset provided by the aggregation module 208-3 or the filtered dataset provided by the filtering module 208-4. The fact count module 208-5 may use entity recognition, key phrase extraction, or semantic analysis to accurately identify and isolate each fact.

After identifying the individual facts, the fact count module 208-5 may count the frequency of each fact across the outputs generated by the different AI threads 108. The frequency of a fact being mentioned is a strong indicator of its reliability. The fact count module 208-5 may implement counting algorithms to determine how often each fact appears across the various thread outputs. For example, the fact count module 208-5 may use hash-based counting for efficiency or more complex statistical methods for aggregating similar but not identical facts. In some example embodiments, slight variations in wording may be normalized to count them as the same fact.

In some embodiments, the fact count module 208-5 may analyze the consistency of each fact by comparing its occurrence across the AI threads 108. Consistent facts may be considered as those that are corroborated by multiple threads 108, and may be flagged as reliable, while inconsistent facts may be marked for further review or filtering. For example, if a fact is mentioned by more than a certain percentage of threads, it may be flagged as consistent. The fact count module 208-5 may also compare the context in which each fact appears to ensure that the consistency is not superficial but contextually accurate.

In some embodiments, when the fact count module 208-5 encounters conflicting facts—different threads providing opposing data—the fact count module 208-5 may implement strategies to resolve such conflicts such as by additional analysis or marking the conflicting facts for deeper review. The fact count module 208-5 may dynamically re-evaluate facts as new data is added or as the verification process uncovers new information. This iterative process ensures that the fact-counting process adapts to evolving data.

By counting and analyzing the frequency of facts across multiple AI threads 108, the fact count module 208-5 significantly enhances the accuracy of the final output, ensuring that only widely corroborated information is used. The consistency analysis capabilities of the fact count module 208-5 ensure that the data used in the final output is not only accurate but also internally consistent, reducing the risk of conflicting or erroneous information.

The final output generation module 208-6 may generate a coherent, accurate response to the user input based on the verified repeated facts.

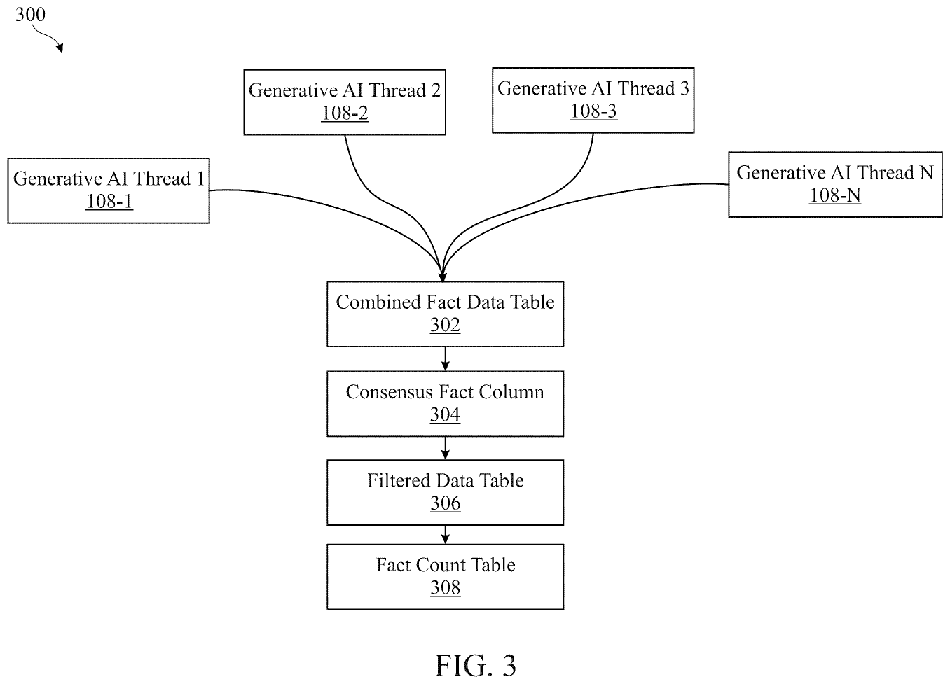

FIG. 3 shows a flow chart of an example method 300 for creating a fact count table, in accordance with embodiments of the present disclosure.

Referring to FIG. 3, the method 300 depicts the underlying concept of parallel prompting implemented by the system 106, which involves running multiple AI threads in parallel. Each AI thread 108 processes the same or slightly varied input prompts independently to generate different outputs (or fact groups). By generating multiple fact groups, the system 106 can capture a broad range of possible responses, which can later be compared and aggregated to identify the most accurate and consistent facts.

At block 302, the method 300 may include generating a combined fact data table (interchangeably referred to as “combined dataset”). The combined fact data table aggregates the individual facts generated by each AI thread 108. In some embodiments, the combined fact data table may include an adaptive aggregation mechanism that assigns weights to facts based on their source thread's reliability or historical accuracy.

At block 304, the method 300 may include adding a consensus fact column in the combined fact data table. It is accomplished by recognizing that two facts are equivalent even if they have been written in different ways.

At block 306, the method 300 may include filtering the fact data table, for example, for systematic errors, duplicate data, and the like. The method 300 may include removing any errors that are consistently generated by the AI threads 108 due to biases in the training data or flaws in the AI models. In some embodiments, the system 106 may implement a real-time error filtering mechanism to identify and correct systemic errors as they occur, rather than post-processing. This may be particularly useful in time-sensitive applications like live data analysis.

At block 308, the method 300 may include generating a fact count table which counts the occurrence of each fact across the different AI threads 108, with a focus on the facts that appear multiple times (and thus are considered more reliable).

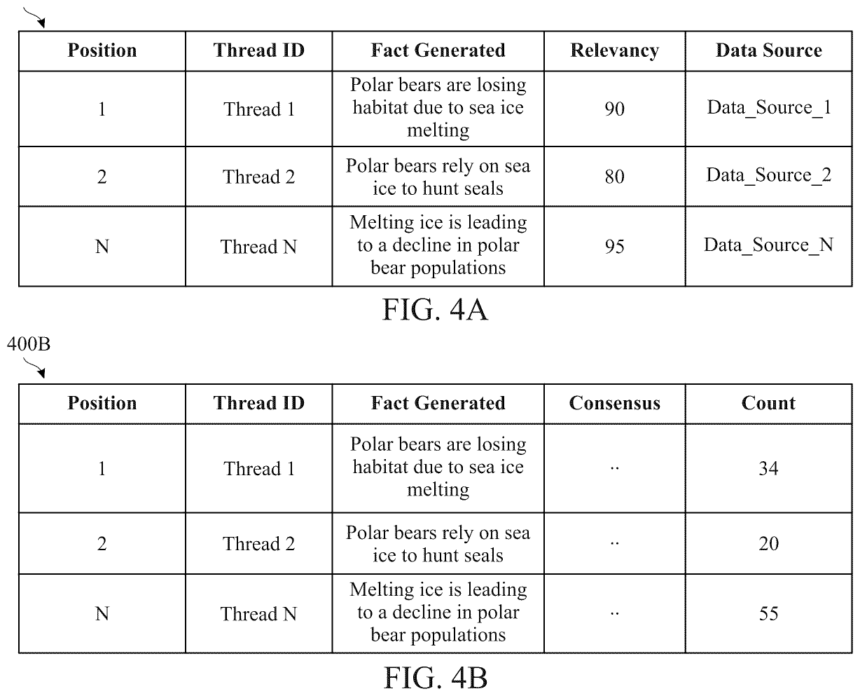

FIGS. 4A and 4B show exemplary representations of a combined fact data table 400A and a fact count table 400B, in accordance with embodiments of the present disclosure.

Referring to FIG. 4A, the combined fact data table 400A refers to a table created by aggregating the fact groups or set of output data generated by the different generative AI threads 108. As an example, the combined fact data table 400A may include position number for reference, thread identification, fact generated by the particular thread, relevance, and data source. It may be appreciated that the column fields may be modified as per requirements within the scope of the present disclosure.

Referring to FIG. 4B, the fact count table 400B refers to a table created by counting the occurrence of facts generated by different generative AI threads 108. As an example, the fact count table 400B may include the count of the fact, in addition to other fields, as shown. It may be appreciated that the column fields may be modified as per requirements within the scope of the present disclosure.

It may be appreciated that the exemplary representations of tables (400A, 400B) may be modular and flexible to accommodate any kind of changes within the scope of the present disclosure.

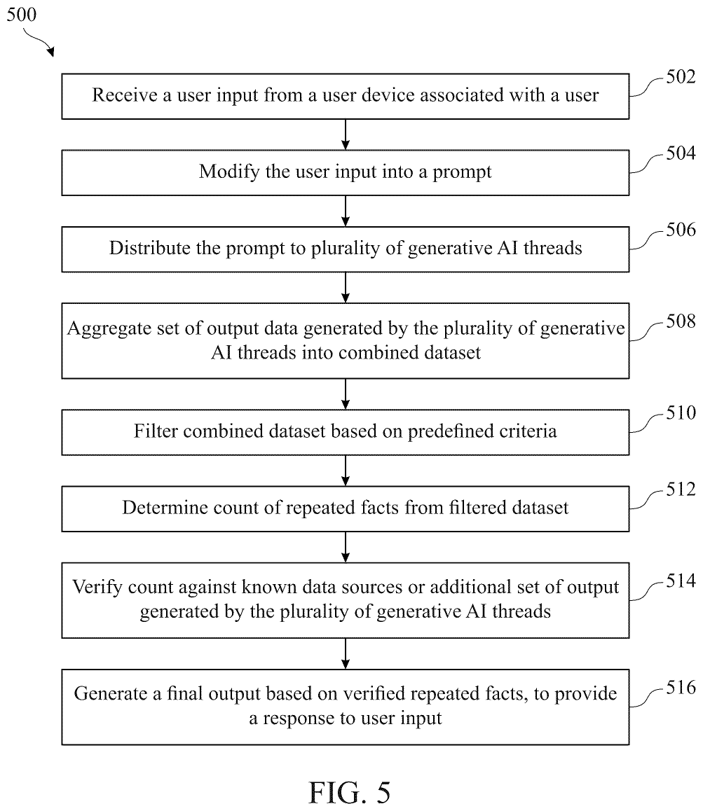

FIG. 5 shows a flow chart of an example method 500 for generating a final output in response to a user input, in accordance with embodiments of the present disclosure. FIG. 5 is explained in conjunction with elements from FIG. 1. The steps from 502 to 516 may be implemented by any computing system, such as by the system 106 of FIG. 1.

Referring to FIG. 5, at block 502, the method 500 may include receiving a user input from a user device 102 associated with a user. At block 504, the method 500 may include modifying the user input into a prompt.

Further, at block 506, the method 500 may include distributing the prompt to a plurality of generative AI threads 108, each configured to independently generate a set of output data in response to the prompt. In some embodiments, the method 500 may include dynamically selecting the plurality of generative AI threads 108 based on the content of the prompt and historical accuracy of the plurality of generative AI threads 108 in generating relevant output data. The plurality of generative AI threads 108 may be deployed in a distributed computing environment, and the system 106 may be configured to optimize resource allocation for processing the prompt across multiple threads.

At block 508, the method 500 may include aggregating the generated set of output data from each of the plurality of generative AI threads 108 into a combined dataset (or fact data table). In some embodiments, the method 500 may include generating consensus data within the combined dataset by identifying and merging equivalent facts that are expressed in different ways or equivalent ways across the plurality of generative AI threads 108 which may include reducing the system output variability to facilitate matching.

At block 510, the method 500 may include filtering the combined dataset based on predefined criteria. In some embodiments, the predefined criteria for filtering the combined dataset may include criteria selected from the group consisting of relevance to the prompt, factual accuracy, alignment with known data sources, and compliance with domain-specific guidelines.

At block 512, the method 500 may include determining a count of repeated facts from the filtered dataset. At block 514, the method 500 may include verifying the count of the repeated facts against known data sources or additional set of output data generated by the plurality of generative AI threads 108. At block 516, the method 500 may include generating a final output based on the verified repeated facts, to provide a response to the user input.

Therefore, in accordance with embodiments of the present disclosure, the system 106 increases the accuracy of the results by introducing redundancy. In traditional single-threaded AI systems, outputs are more susceptible to inaccuracies or hallucinations. However, by utilizing multiple threads, each generating unique outputs, the system 106 may cross-reference these outputs to identify commonalities. Facts or data points that are repeated across several threads are more likely to be accurate, as they are independently corroborated by different models or variations of the same model. This redundancy ensures that the final output is not reliant on the potential shortcomings of a single AI thread, thereby significantly enhancing the reliability of the information provided.

Further, the system 106 filters the systematic errors that may occur due to the nature of systematic generative AI hallucinations. Since each AI thread operates independently, the system 106 can compare the outputs to identify systematic hallucination patterns of error that may be present in one or more threads. By recognizing and filtering these systematic errors during the aggregation and consensus-building phases, the system 106 mitigates the risk of propagating inaccurate or biased information. For actual hallucinations also known as spontaneous hallucinations they generally will only be present in a single thread and are reliably removed. This is particularly valuable in applications where the accuracy of the output is critical.

Additionally, the system 106 provides dynamic and contextually relevant outputs through its modular design. Each AI thread can be tailored or specialized to focus on different aspects of a query, such as contextual relevance, factual accuracy, or domain-specific knowledge. This modularity allows the system 106 to adapt to various domains and types of queries, ensuring that the final output is accurate and contextually appropriate for the user's needs. For example, in an educational setting, some threads may be optimized for readability and engagement, while others may focus on factual accuracy and depth of content. This adaptability makes the system 106 versatile and capable of generating outputs that are finely tuned to the specific requirements of different use cases.

By distributing the processing load across multiple AI threads, the system 106 can manage more complex tasks without a significant increase in processing time. This parallel processing capability allows the system 106 to maintain high performance even when dealing with large datasets or intricate queries that would otherwise require significant computational resources if handled by a single-threaded model. Further, the real-time aggregation of outputs from multiple AI threads, combined with filtering for relevancy and accuracy, enables the system 106 to generate outputs that are ready for immediate use without extensive post-processing. This is particularly advantageous in real-time applications such as customer support, where timely and accurate responses are essential. The system's ability to deliver high-quality, validated information quickly enhances its utility in fast-paced environments where decision-making needs to be both rapid and reliable.

It will be appreciated that the blocks shown in FIG. 5 are merely illustrative. Other suitable blocks may be used for the same, if desired. Moreover, the blocks of the method 500 may be performed in any order and may include additional blocks.

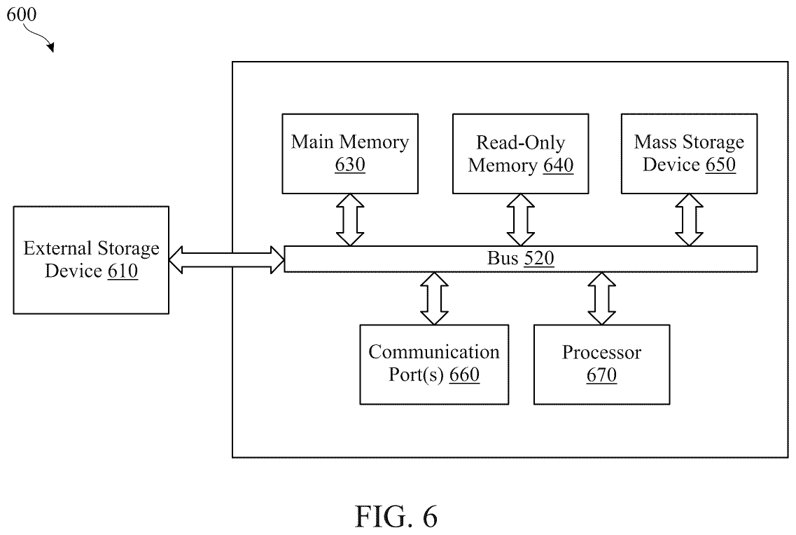

FIG. 6 illustrates an example computer system 600 in which or with which embodiments of the present disclosure may be implemented. In some embodiments, the system 106 of FIG. 1 may be implemented as the computer system 600. Alternatively, or additionally, the user device 102 of FIG. 1 may also be implemented as the computer system 600.

As shown in FIG. 6, the computer system 600 may include an external storage device 610, a bus 620, a main memory 630, a read-only memory 640, a mass storage device 650, communication port(s) 660, and a processor 670. A person skilled in the art will appreciate that the computer system 600 may include more than one processor and communication ports. The processor 670 may include various modules associated with embodiments of the present disclosure. The communication port(s) 660 may be chosen depending on a network, such a Local Area Network (LAN), Wide Area Network (WAN), or any network to which the computer system 600 connects. The main memory 630 may be Random-Access Memory (RAM), or any other dynamic storage device commonly known in the art. The read-only memory 640 may be any static storage device(s) e.g., but not limited to, a Programmable Read Only Memory (PROM) chips for storing static information e.g., start-up or BIOS instructions for the processor 670. The mass storage device 650 may be any current or future mass storage solution, which can be used to store information and/or instructions.

The bus 620 communicatively couples the processor 670 with the other memory, storage, and communication blocks. Optionally, operator and administrative interfaces, e.g., a display, keyboard, joystick, and a cursor control device, may also be coupled to the bus 620 to support direct operator interaction with the computer system 600. Other operator and administrative interfaces can be provided through network connections connected through communication port(s) 660. The external storage device 610 may be any kind of external hard-drives, floppy drives, or the like. Components described above are meant only to exemplify various possibilities. In no way should the aforementioned exemplary computer system 600 limit the scope of the present disclosure.

The methods described herein may be performed using the systems described herein. In addition, it is contemplated that the methods described herein may be performed using systems different than the systems described herein. Moreover, the systems described herein may perform the methods described herein and may perform or execute instructions stored in a non-transitory computer-readable storage medium (CRSM). The CRSM may comprise any electronic, magnetic, optical, or other physical storage device that stores executable instructions. The instructions may comprise instructions to cause a processor to perform or control performance of operations of the proposed methods. It is also contemplated that the systems described herein may perform functions or execute instructions other than those described in relation to the methods and CRSMs described herein.

Furthermore, the CRSMs described herein may store instructions corresponding to the methods described herein, and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSMs described herein.

In some embodiments the method or methods described above may be executed or carried out by a computing system (for example, the computer system 600 of FIG. 6) including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

In some embodiments, the method may further use Retrieval Augmented Generation system comprising inputting relevant data using retrieved or user furnished sources or data as part of the input to the plurality of generative AI threads to narrow the generated output data. In some embodiments, the plurality of generative AI threads may be trained in a specific domain of knowledge, interpretation of specific types inputs, or both to optimize aspects of the thread output. This may provide the potential modifications of the base AI(s) in terms of what they are outputting as threads by training. For example in medicine a pre-trained system specific to a particular application may output threads that are more inclusive of domain knowledge, have a higher factuality, and be easier to update as new information needs to be included on a regular basis. In an embodiment of the method of the invention, the generated set of output data may trained to facilitate interpretation, factuality, processing speed, comparison between outputs, types of outputs, or other optimizations of outputs. Optical interpretation of the “world” around a robot (additional inputs) could help to optimize generated threads about how to best create a list of actions to solve a problem. The analysis of one of the “steps” using the trained AI and threads would then lead to actual movement instructions. The generated set of output data is further analysed to create a new set of fact data that is used to create another set of output data.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

What is claimed is

1. A computer-implemented method, comprising:
receiving, by a system, a user associated input from a device, or devices, associated with a user;
modifying, by the system, the user associated input into an AI input or a prompt;
distributing, by the system, the AI input to a plurality of generative artificial intelligence (AI) threads, each configured to independently generate a set of output data in response to the AI input;
aggregating, by the system, the generated set of output data from each of the plurality of generative AI threads into a combined dataset;
breaking down contents of the combined dataset into discrete atomic facts creating a fact dataset;
filtering, by the system, the combined fact dataset based on predefined criteria;
determining, by the system, a count of repeated facts from the filtered combined fact dataset;
verifying, facts based on the count of the repeated facts against an empirically derived probability model, or known data sources or additional set of output data generated by the plurality of generative AI threads; and
generating, by the system, a final output based on the verified facts that form a verified final fact table, to provide a response to the user input.

2. The method of claim 1, further comprising dynamically selecting the plurality of generative AI threads based on the content of the AI input and historical accuracy of the plurality of generative AI threads in generating relevant output data.

3. The method of claim 1, further using Retrieval Augmented Generation system comprising inputting relevant data using retrieved or user furnished sources or data as part of the input to the plurality of generative AI threads to narrow or augment the generated output.

4. The method of claim 1, wherein the plurality of generative AI threads is trained in a specific domain of knowledge, interpretation of specific types of inputs, or both to optimize aspects of the thread output.

5. The method of claim 1, wherein the generated set of output data is used to facilitate interpretation, factuality, processing speed, comparison between outputs, types of outputs, or other optimizations of outputs.

6. The method of claim 1, wherein the generated set of output data is further analyzed to create a new set of fact data that is used to create another set of output data.

7. The method of claim 1, wherein the predefined criteria for filtering the combined fact dataset is selected from the group consisting of relevance to the prompt, exclusion of data matching known or discovered hallucination patterns, factual accuracy, alignment with known data sources, and compliance with domain-specific guidelines.

8. The method of claim 1, wherein the system generates consensus data within the combined dataset by identifying and merging equivalent facts that are expressed in different ways or equivalent ways across the plurality of generative AI threads.

9. The method of claim 8, wherein system variability is reduced to facilitate some forms of fact matching in generating consensus data.

10. The method of claim 1, wherein the prompt is broken down into smaller prompts, with or without additional data added, that then undergo a procedure, wherein the proposed final output of the prompt, the output before being delivered as a response to the user, is further broken down into a set of facts by chunking it into labeled portions and querying what facts are present, which is then compared to a final fact table to find any additional unverified facts in the proposed final output;
if the additional unverified facts are present in a labeled portion, that portion is regenerated and retested until the labeled portion is verified as factual or a defined limit to the number of regenerations is reached and a failure is noted;
and if the additional unverified facts are repeated upon multiple regenerations, their factuality is tested using the method as previously described, using facts gathered from the multiple generations; all unverified facts including those only generated once are potentially verified by using other data sources, by querying the user, or by a method, wherein;
if these facts are verified, they are added to the final fact table, the labeled portion is verified as being factual if all facts contained in the labeled portion are also contained in the final fact table;
If the prompt was broken, initially, into the several smaller prompts, the factually verified results for each smaller prompt are combined together;
finally the proposed final output is tested to verify that it is a complete answer to the prompt of the user input.

11. The method of claim 1, wherein the plurality of generative AI threads is deployed in a distributed computing environment, and the system is configured to optimize resource allocation for processing the prompt across multiple threads.

12. The method of claim 1, wherein the system comprises:
a computer workstation, a mainframe computer, a handheld computer, a cellular/mobile phone, or a computing device;
a database server, a file server, a web server, a media server, an application server, a mainframe server, a cloud server, or other types of servers;
the system implemented as a cloud server executing operations through web applications, cloud applications, API requests, Hypertext Transfer Protocol (HTTP) requests, repository operations, or file transfer; or
the system implemented as a plurality of distributed cloud-based resources.

13. The method of claim 1, wherein the user device comprises a digital platform communicatively coupled with the system, wherein the digital platform is a mobile application installed on the user device, a web application, a desktop application, an application hosted on the system, an AI assistant utilizing Natural Language Processing (NLP) to understand and process user inputs in natural language, a spoken language interpreter that translates speech into a user input, motion detection inputs from a user or device that has been configured to output them as generative AI input, optical inputs that have been configured as generative AI input, other sensors inputs passing through a device that have been configured to output them as generative AI input, a brain wave interpreter that translates such signals into a user input, or programs that have been configured to interpret stored data for generative AI inputs.

14. The method of claim 1, wherein the user device comprises suitable logic, circuitry, interfaces, and/or code that is configured to receive the user associated input from the user and transmit the received user associated input to the system, or transmit a preprogrammed optimized instructions in response to either the user associated input or analysis of such input, or both;
where in the user device is a robot, a car, a telephone, a smartphone, a cellular phone, a mobile phone, a personal digital assistant (PDA) device, a tablet, a gaming device, a computing device, an imaging device, a mainframe machine, a server, a computer workstation, a virtual reality (VR) device, or an augmented reality (AR) device.

15. The method of claim 1, wherein the system and the user device communicate with each other through a communication network comprising a cloud network, a Wireless Fidelity (Wi-Fi) network, a Personal Area Network (PAN), a Local Area Network (LAN), a fiber optic network, or a Metropolitan Area Network (MAN), or other similar types of networks.

16. The method of claim 1, wherein the user associated input is a complex or multifaceted query, and the system decomposes the query into simpler, more manageable sub-queries, allowing a set of AI threads from the plurality of AI threads to focus on a specific aspect of the query, which can then be aggregated to form a comprehensive response.

17. The method of claim 1, wherein the system is configured to learn from its outputs over time, adapting to new data and refining its processes based on feedback.

18. The method of claim 1, further comprising:
(i) automatically generating, for at least a subset of verified facts stored in the verified final fact table, one or more synthetic queries, each synthetic query being configured to elicit a corresponding verified atomic fact when processed by a generative artificial intelligence (AI) model;
(ii) forming a plurality of training pairs, each comprising a synthetic query and the corresponding verified atomic fact;
(iii) accumulating the plurality of training pairs into a reinforcement dataset; and
(iv) updating at least one generative AI model using the reinforcement dataset by training, fine-tuning, reinforcement learning, or prompt-weighted steering, thereby enabling the generative AI model to incorporate the verified atomic facts over time.
